(19) United States
(12) Patent Application Publication
(10) Pub. No.: US 2020/0185734 A1
(43) Pub. Date: Jun. 11, 2020

(54) VOLTAGE CONTROL METHOD FOR FUEL CELL STACK AND FUEL CELL SYSTEM FOR VEHICLE

(71) Applicants: Hyundai Motor Company, Seoul (KR); Kia Motors Corporation, Seoul (KR)

(72) Inventor: Yei Sik Jeon, Seoul (KR)

(21) Appl. No.: 16/299,406

(22) Filed: Mar. 12, 2019

(30) Foreign Application Priority Data
Dec. 7, 2018 (KR) 10-2018-0157547

(51) Int. Cl. H01M 8/04858; H01M 8/04537; H01M 8/04664; H01M 8/04828; H01M 16/00

(52) U.S. Cl. CPC H01M 8/0488; H01M 8/04589; H01M 8/04679; H01M 2250/20; H01M 8/04947; H01M 16/006; H01M 8/04559

(57) ABSTRACT

A voltage control method for a fuel cell stack is provided. The method includes determining whether a performance of the fuel cell stack is degraded based on a reference performance that corresponds to the performance of the fuel cell stack evaluated at a reference time point and an evaluated performance that corresponds to the performance of the fuel cell stack evaluated at a predetermined time point after the reference time point. Additionally, the method includes setting a reference voltage, which is set as a maximum allowable voltage for adjusting a voltage of the fuel cell stack, to be less than an existing reference voltage in response to determining that the performance of the fuel cell stack is degraded.

### CROSS-REFERENCE TO RELATED APPLICATION

This application is based on and claims the benefit of priority to Korean Patent Application No. 10-2018-0157547, filed on Dec. 7, 2018, the disclosure of which is incorporated herein in its entirety by reference.

### TECHNICAL YIELD

The present invention relates to a voltage control method for a fuel cell stack and a fuel cell system for a vehicle, and more particularly, to a fuel cell stack and a fuel cell system for a vehicle, that resolve errors occurring when a predetermined voltage is fixed by changing the predetermined voltage in accordance with a predetermined reference.

### BACKGROUND

A fuel cell system includes a fuel cell stack having an air electrode, an electrolyte membrane, and a fuel electrode. During an operation of the fuel cell system, air is supplied to the air electrode, hydrogen is supplied to the fuel electrode, and the fuel cell system produces electric power through a reaction between the air and the hydrogen. However, when the fuel cell stack is exposed to a high electric potential, the fuel cell stack deteriorates, and a durability of the fuel cell stack is also deteriorated.

This particularly becomes a problem at the air electrode of the fuel cell stack. To prevent the deterioration caused by high electrical potential, a voltage of the fuel cell stack is adjusted so that only a predetermined voltage or less is generated by the fuel cell stack. The predetermined voltage (e.g., reference voltage) is set at the beginning of life of the fuel cell stack by considering characteristics of the air electrode or a capacity of battery. In a conventional fuel cell system, the set predetermined voltage is not changed. Since a variety of problems occurs when the predetermined voltage is fixed as described above, a method for solving the problems is required.

### SUMMARY

The present disclosure provides a voltage control method for a fuel cell stack and a fuel cell system for a vehicle that resolve problems or errors occurring when a predetermined voltage (e.g., reference voltage) is fixed by changing the predetermined voltage in accordance with a predetermined reference. The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, a voltage control method for a fuel cell stack may include determining whether a performance of the fuel cell stack is degraded based on a reference performance that corresponds to the performance of the fuel cell stack evaluated at a reference time point and an evaluated performance that corresponds to the performance of the fuel cell stack evaluated at a predetermined time point after the reference time point and setting a reference voltage, which is set as a maximum allowable voltage for adjusting a voltage of the fuel cell stack, to be less than an existing reference voltage in response to determining that the performance of the fuel cell stack is degraded.

The reference performance is evaluated based on a reference current that is a maximum current of the fuel cell stack, which is generated at the existing reference voltage, with respect to a time point at which the existing reference voltage is set before the predetermined time point. The evaluated performance is evaluated based on an evaluated current that is a maximum current generated at the existing reference voltage with respect to the predetermined time point. The method may further include determining that the performance of the fuel cell stack is degraded when the evaluated current is less than a predetermined value selected from a range of about 85% to about 100% of the reference current

When an electric power derived from a region, which is defined by an y-axis indicating the voltage, a horizontal line drawn parallel to an x-axis indicating a current at the reference voltage, and a performance curve in a current-voltage performance curve of the fuel cell stack, is referral to as a chargeable capacity, the reference performance may be evaluated based on a reference capacity that is the chargeable capacity derived from an initial reference voltage set at a beginning of life with respect to a performance curve of the beginning of life. The evaluated performance may be evaluated based on an evaluated capacity that is the chargeable capacity derived from the existing reference voltage with respect to a performance curve of the predetermined time point.

The method may further include determining that the performance of the fuel cell stack is degraded when the evaluated capacity is less than a predetermined value selected from a range from about 85% to 100% of the reference capacity and setting the reference voltage to a voltage that allows the chargeable capacity to be equal to the reference capacity with respect to the performance curve of the predetermined time point in response to determining that the performance of the fuel cell stack is degraded. Additionally, the reference voltage may be set to a voltage that allows the chargeable capacity to become a predetermined value selected from a range from about 85% to 100% of the reference capacity with respect to the performance curve of the predetermined time point in response to determining that the performance of the fuel cell stack is degraded.

When an electric power derived from a region, which is defined by an y-axis indicating the voltage, a horizontal line drawn parallel to an x-axis indicating a current at the reference voltage, and a performance curve in a current-voltage performance curve of the fuel cell stack, is referral to as a chargeable capacity and the chargeable capacity derived from an initial reference voltage set at a beginning of life with respect to a performance curve of the beginning of life is referred to as a reference capacity, the method may include setting the reference voltage to a voltage that allows the chargeable capacity to become a predetermined value selected from a range from about 85% to 100% of the reference capacity with respect to the performance curve of the predetermined time point in response to determining that the performance of the fuel cell stack is degraded.

According to another aspect of the present disclosure, a fuel cell system for a vehicle may include at least one processor, a fuel cell stack connected to the at least one processor, a battery connected to the at least one processor, and a memory connected to the at least one processor and configured to store a plurality of instructions. The instructions, when executed by the processor, allow the processor to determine whether a performance of the fuel cell stack is degraded based on a reference performance that corresponds to the performance of the fuel cell stack evaluated at a reference time point and an evaluated performance that corresponds to the performance of the fuel cell stack evaluated at a predetermined time point after the reference time point and to set a reference voltage, which is set as a maximum allowable voltage for adjusting a voltage of the fuel cell stack, to be less than an existing reference voltage in response to determining that the performance of the fuel cell stack is degraded.

The instructions, when executed by the processor, allow the processor to charge an electric power produced by the fuel cell stack into the battery when the voltage greater than the reference voltage is generated by the fuel cell stack to decrease the voltage of the fuel cell stack. Accordingly, although the voltage difference occurs between the cells due to the performance degradation of the fuel cell stack, the decrease in durability of the fuel cell stack in the prior art due to the high electric potential applied to the fuel cell stack may be prevented since, in the present disclosure, the reference voltage is decreased based on the performance degradation. In addition, even though the performance of the fuel cell stack may be degraded, the charge amount of the battery may be prevented from decreasing due to the performance degradation of the fuel cell stack since the reference voltage is decreased based on the performance degradation.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram illustrating a fuel cell system for a vehicle according to an exemplary embodiment of the present disclosure;

FIG. 2 is a graph illustrating a current-voltage performance curve of a fuel cell stack according to an exemplary embodiment of the present disclosure;

FIG. 3 is a graph illustrating a stack voltage distribution at the beginning of life of a fuel cell stack according to an exemplary embodiment of the present disclosure;

FIG. 4 is a graph illustrating a stack voltage distribution after the beginning of life of the fuel cell stack according to an exemplary embodiment of the present disclosure;

FIG. 5 is a graph illustrating a stack voltage distribution after a reference voltage is decreased according to an exemplary embodiment of the present disclosure; and

FIG. 6 is a flowchart illustrating a voltage control method for a fuel cell stack according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referral to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, exemplary embodiments of the present disclosure will be described in detail with reference to the accompanying drawings. In the drawings, the same reference numbers will be used throughout to designate the same or equivalent elements. In addition, a detailed description of well-known features or functions will be ruled out in order not to unnecessarily obscure the gist of the present disclosure.

In describing elements of exemplary embodiments of the present disclosure, the terms 1^{st}, 2^{nd}, first, second, A, B, (a), (b), and the like may be used herein. These terms are only used to distinguish one element from another element, but do not limit the corresponding elements irrespective of the order or priority of the corresponding elements. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

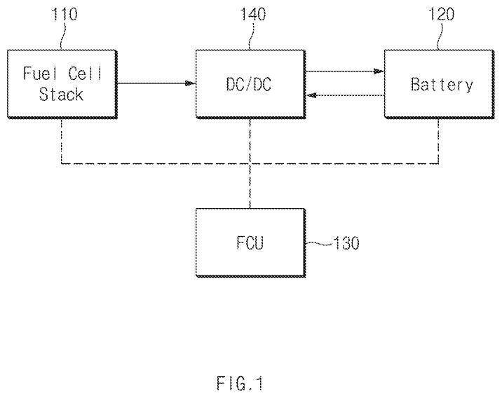

FIG. 1 is a block diagram illustrating a fuel cell system for a vehicle according to an exemplary embodiment of the present disclosure. The fuel cell system for the vehicle according to an exemplary embodiment of the present disclosure may include a fuel cell stack 110, a battery 120, and a fuel cell controller 130. The fuel cell stack 110 may include an air electrode, an electrolyte membrane, and a fuel electrode, and detailed descriptions thereof will be omitted since they are well-known and common. The fuel cell stack 110 may include an apparatus (e.g., surround view monitors, SVM or other sensor) configured to monitor a voltage of the fuel cell stack 110. In addition, a current sensor may be connected to the fuel cell stack 110 to measure a current flowing through the fuel cell stack.

The battery 120 may be charged with an electric power produced excessively in the fuel cell stack. For example, when the voltage is generated greater than a reference voltage, which is described later, in the fuel cell stack 110, the battery 120 may be charged with the electric power. The electric power produced in the fuel cell stack 110 may be charged in the battery 120 via a high voltage direct current-direct current converter (HDC) 140. The battery 120 may include an apparatus (e.g., battery management system, BMS) configured to monitor the voltage of the battery 120. For reference, FIG. 1 shows the HDC 140, which is a unidirectional type, configured to receive an input from the fuel cell stack 110, however, it should not be limited thereto or thereby. In other words, the HDC 140 may be a bidirectional type HDC configured to output the input from the battery 120 to the fuel cell stack 110. For example, the electric power of the battery may be discharged through the HDC 140 to the fuel cell stack.

Additionally, the fuel cell controller 130 may be configured to operate the fuel cell stack 110, the battery 120, and the HDC 140. Accordingly, the fuel cell controller 130 may include at least one processor and a memory connected to the at least one processor and configured to store a plurality of instructions. The at least one processor may be connected to the fuel cell stack 110, the battery 120, and the HDC 140 for control thereof. The instructions may allow the processor to execute the controls described below.

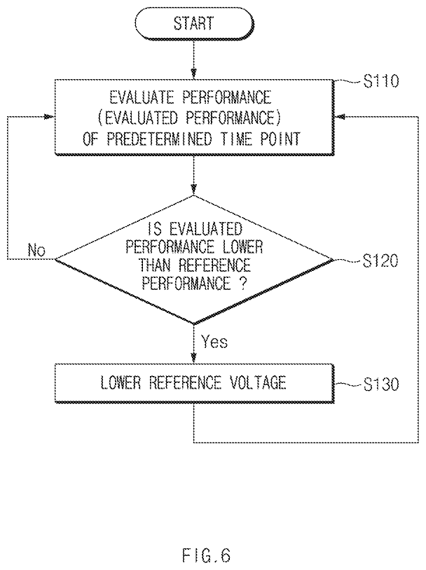

Hereinafter, operations of the system according to the present exemplary embodiment will be described. First, the fuel cell controller may be configured to evaluate a performance of the fuel cell stack at a predetermined time point (S110 of FIG. 6). The fuel cell controller may then be configured to determine whether the evaluated performance of the fuel cell stack is deteriorated based on a reference performance and the evaluated performance. Accordingly, the evaluated performance of the fuel cell stack may be determined.

The reference performance may correspond to the performance of the fuel cell stack evaluated at a reference time point, and the evaluated performance may correspond to the performance of the fuel cell stack evaluated at the predetermined time point after the reference time point. For example, the reference time point may be a beginning of life or, may be, when the reference voltage described later has been changed, a time point when the existing reference voltage, which has already been set at the time point of evaluating the performance of the fuel cell stack by the fuel cell stack controller, is set. The predetermined time point may be a time point after the reference time point, i.e., a current time point at which the performance of the fuel cell stack is evaluated. The predetermined time point may be determined based on information regarding a vehicle mileage, a total operation time of the fuel cell stack, a voltage of the fuel cell stack, and a current of the fuel cell stack. When the reference performance is a performance related to the beginning of life, the reference performance may be previously stored in a memory.

The reference voltage may be a voltage set as a maximum allowable voltage for adjusting the voltage of the fuel cell stack. When the fuel cell stack is exposed to a high electric potential, the fuel cell stack is deteriorated, and a durability of the fuel cell stack is also deteriorated. This causes a problem at the air electrode of the fuel cell stack. Accordingly, in the present disclosure, the voltage of the fuel cell stack may be adjusted using the HDC to generate a predetermined voltage or less by the fuel cell stack. The predetermined voltage may be the reference voltage. The reference voltage may be set at the beginning of life of the fuel cell stack by considering characteristics of the air electrode or the capacity of the battery. In a conventional fuel cell system, the set reference voltage is not changed, however, the reference voltage of the fuel cell stack according to the present invention is changed as described below.

For example, when the voltage equal to or greater than the reference voltage is generated by the fuel cell stack, the electric power produced by the fuel cell stack may be charged in the battery via the HDC 140. Accordingly, the voltage of the fuel cell stack may be decreased. Since the capacity of the battery is limited, the battery may not accept all of the electric power when an excess electric power produced by the fuel cell increases. Then, an amount of air supplied to the air electrode may be reduced to decrease the generation of the excess electric power itself.

The performance of the fuel cell stack may be evaluated as follows.

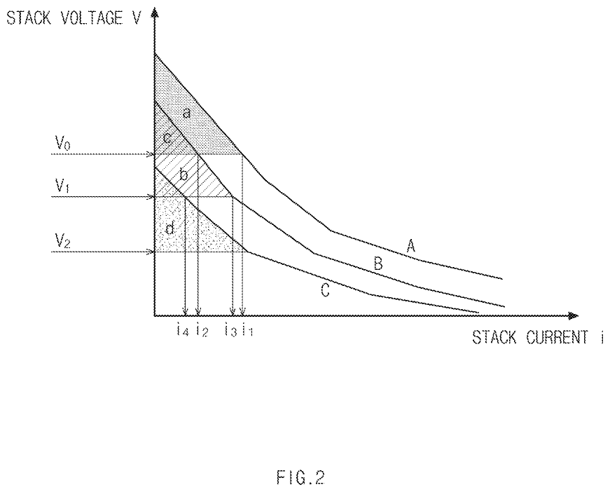

First, the performance of the fuel cell stack may be evaluated based on a maximum current of the fuel cell stack, which is generated at the reference voltage. FIG. 2 is a graph illustrating a current-voltage performance curve of the fuel cell stack. Generally, a fuel cell stack is deteriorated with use and when the fuel cell stack is deteriorated, the performance curve of FIG. 2 moves toward the origin of the graph. For example, when the performance curve of the beginning of life is a curve “A” in FIG. 2, the performance curve is gradually changed to a curve “B” and a curve “C” as the fuel cell stack is used. Accordingly, the maximum current of the fuel cell stack, which is generated at the reference voltage V0, is “i1” when the performance curve is the curve “A”, and is “i2” when the performance curve is the curve “B”. As described above, the maximum current generated at the reference voltage gradually decreases in accordance with the deterioration.

Second, the performance of the fuel cell stack may be evaluated based on a chargeable capacity. The chargeable capacity will be described with reference to FIG. 2. FIG. 2 shows a region “a” defined by a y-axis indicating the voltage, a horizontal line drawn parallel to an x-axis indicating the current at the reference voltage “V0”, and the performance curve “A”. An area of the region “a” refers to the electric power obtained by multiplying the current and the voltage. As described above, the electric power generated greater than the reference voltage may be charged in the battery to adjust the voltage of the fuel cell stack to be less than the reference voltage. Thus, the region “a” of FIG. 2 may refer to a chargeable capacity of the battery charged by the fuel cell stack. However, when the performance curve is changed to the curve “B” from the curve “A” due to the deterioration of the fuel cell stack, the chargeable capacity is changed to a region “c” from the region “a”. The region “c” is defined by the y-axis indicating the voltage, the horizontal line drawn parallel to the x-axis indicating the current at the reference voltage “V0”, and the performance curve “B”.

Further, the fuel cell controller may be configured to determine whether the performance of the fuel cell stack is degraded based on the reference performance and the evaluation performance (S120 of FIG. 6). This determination may be performed as follows.

First, the performance degradation of the fuel cell stack may be determined based on a reference current and an evaluated current as described below. When the maximum current of the fuel cell stack, which is generated at the reference voltage, decreases, the performance of the fuel cell stack may be determined to be degraded as described below with reference to FIG. 2. When it is assumed that the reference voltage at the beginning of life is “V0” and the maximum current at the beginning of life is “i1”, the maximum current generated at the reference voltage V0 may be “i2” less than “i1” at a certain time point after the beginning of life, and then the movement of the performance curve from “A” to “B” may be determined to be due to the degradation of the fuel cell stack. In addition, for example, when the reference voltage is changed to “V1” from “V0”, although the maximum current is “i3” at the time point when the reference voltage “V1” is set, the maximum current generated at the reference voltage V1 may be “i4” less than “i3” at a certain time point after the time point when the reference voltage “V1” is set. This also may indicates the degradation of the fuel cell stack.

Consequently, the performance degradation of the fuel cell stack may be evaluated based on the reference performance and the evaluated performance. The reference performance may be evaluated based on the reference current that is the maximum current of the fuel cell stack generated at an existing reference voltage based on a time point at which the existing reference voltage, i.e., the reference voltage already set with respect to a current time point at which the performance of the fuel cell stack is evaluated, was set. The evaluated performance may be evaluated based on the evaluated current that is the maximum current generated at the existing reference voltage with respect to the current time point at which the performance of the fuel cell stack is evaluated, i.e., the predetermined time point.

Meanwhile, the fuel cell controller may be configured to determine that the performance of the fuel cell stack is degraded when the evaluated current is less than a predetermined value selected from a range of about 85% to about 100% of the reference current. For example, when the evaluated current is less than a value corresponding to about 95% of the reference current and this may be expressed as a decrease rate of the evaluated current. When the decrease rate is expressed as ‘evaluation current/reference current’, the performance of the fuel cell stack may be determined to be degraded when the decrease rate is less than about 0.95 (95%). In other words, the fuel cell controller may be configured to determine whether the performance of the fuel cell stack is degraded based on the decrease rate. A lower limit value, e.g., about 85%, of the above-mentioned range may be defined as a value determined based on a standard deviation of the current at the reference voltage and a measurement error. The standard deviation of the current at the reference voltage may be about 12%.

Second, the performance degradation of the fuel cell stack may be evaluated based on a reference capacity and an evaluated capacity. When the chargeable capacity derived from the reference voltage decreases, the performance of the fuel cell stack may be determined to be degraded which will be described with reference to FIG. 2. When the reference voltage at the beginning of life is “V0”, the chargeable capacity derived from the reference voltage V0 at the time point of the beginning of life may be defined in the region “a”, and the chargeable capacity derived from the reference voltage V0 at the certain time point after the beginning of life may be defined in the region “c”. Accordingly, the performance curve may be determined to move to the curve “B” from the curve “A” due to the degradation of the fuel cell stack.

Consequently, the performance degradation of the fuel cell stack may be evaluated based on the reference performance and the evaluated performance. The reference performance may be evaluated based on the reference capacity (e.g., the capacity derived from the region “a”) that is the chargeable capacity derived from an initial reference voltage (e.g., V0) set at the beginning of life with respect to the performance curve (e.g., A) at the beginning of life. The evaluated performance may be evaluated based on the evaluated capacity (e.g., the capacity derived from the region “c”) that is the chargeable capacity derived from the existing reference voltage (e.g., V0) with respect to the performance curve (e.g., B) at the predetermined time point.

For reference, the performance curve graph may be obtained by measuring the current and voltage of the fuel cell stack during an operation of a fuel cell vehicle. As another way, the performance curve graph or a performance curve mapping table may be previously experimentally obtained and stored in a memory.

Meanwhile, the fuel cell controller may be configured to determine that the performance of the fuel cell stack is degraded when the evaluated capacity is less than a predetermined value selected from a range of about 85% to about 100% of the reference capacity, for example, the evaluated capacity is less than a value corresponding to about 95% of the reference capacity. This may be expressed as a decrease rate of the evaluated capacity. When the decrease rate is expressed as ‘evaluation capacity/reference capacity’, the performance of the fuel cell stack may be determined to be degraded when the decrease rate is less than about 0.95 (95%). In other words, the fuel cell controller may be configured to determine whether the performance of the fuel cell stack is degraded based on the decrease rate.

Meanwhile, the performance of the fuel cell stack may be evaluated based on an amount of electricity generated by the fuel cell stack in a high electric potential region greater than the reference voltage. This may be substantially the same as the above-described chargeable capacity. The fuel cell controller may be configured to set the reference voltage to be less than the existing reference voltage that is previously set in response to determining that the performance of the fuel cell stack is degraded (S130 of FIG. 6).

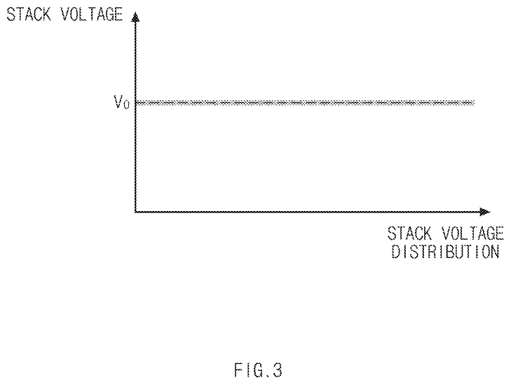

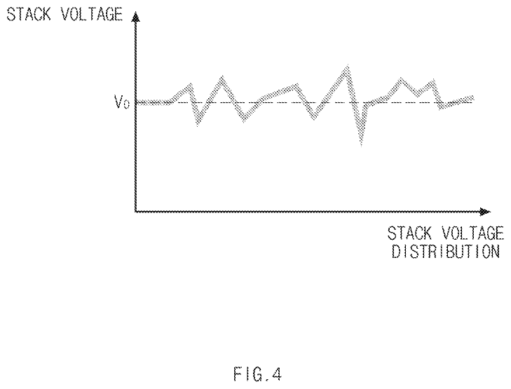

FIG. 3 is a graph illustrating a stack voltage distribution at the beginning of life of the fuel cell stack, and FIG. 4 is a graph illustrating a stack voltage distribution after the beginning of life of the fuel cell stack. As shown in FIG. 3, there is no difference in voltage between cells that form the fuel cell stack at the beginning of life. However, the performance degradation of the fuel cell stack occurs as a driving time of the vehicle elapses. In particular, the performance of discharging water from the air electrode varies from cell to cell. Accordingly, when the driving time elapses, the voltage difference occurs between the cells as shown in FIG. 4, and this causes a voltage exceeding the reference voltage to be applied to some cells.

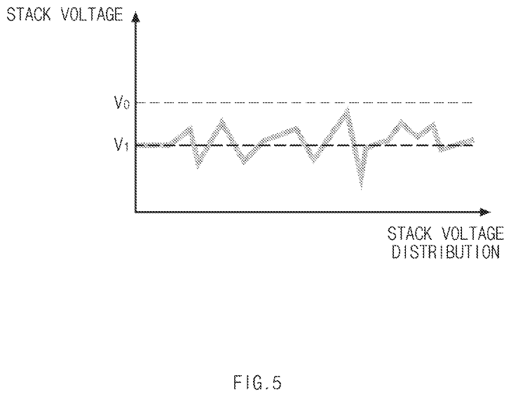

However, the fuel cell system according to the present exemplary embodiment may be configured to set the reference voltage to be less than the existing reference voltage that is previously set in response to determining that the performance of the fuel cell stack is degraded. In other words, as shown in FIG. 5, the fuel cell system according to the present exemplary embodiment may be configured to decrease the reference voltage from V0 to V1. Therefore, although the voltage difference occurs between the cells, the voltage difference occurs around the reference voltage V1 that is newly set. In particular, since the reference voltage V1 is set to be less than the reference voltage V0 set at the beginning of life by considering the deterioration of the fuel cell, the durability deterioration of the fuel cell stack due to the high electric potential applied to the fuel cell stack may be prevented. Instead, the durability of the fuel cell stack may be maximized. When decreasing the reference voltage due to the degradation of the fuel cell stack, the reference voltage that is newly set may be set to a voltage that allows the chargeable capacity to be the same as the reference capacity with reference to the predetermined time point.

The following descriptions will be described with reference to FIG. 2. The reference capacity that is the chargeable capacity at the beginning of life may be derived from the region “a”. When the performance of the fuel cell stack is degraded as the driving time elapses, the chargeable capacity at the current time point may be derived from the region “c”. In particular, the new reference voltage may be set to the voltage V1 that results in the same capacity as the reference capacity with respect to the performance curve B at the current time point. In other words, areas of the following two regions may become equal to each other by setting the reference voltage to “V1”.

The region “a” defined by the y-axis, the horizontal line drawn parallel to the x-axis at the reference voltage “V0”, and the performance curve “A”

The region “b” defined by the y-axis, the horizontal line drawn parallel to the x-axis at the reference voltage “V1”, and the performance curve “B”

When the performance of the fuel cell stack is further degraded as the driving time further elapses, a new reference voltage V2 may be set such that areas of the following two regions become equal to each other.

The region “a” defined by the y-axis, the horizontal line drawn parallel to the x-axis at the reference voltage “V0”, and the performance curve “A”

The region “d” defined by the y-axis, the horizontal line drawn parallel to the x-axis at the reference voltage “V2”, and the performance curve “C”

When the new reference voltage is set as described above, a charge amount of the battery may be prevented from decreasing due to the degradation in performance of the fuel cell stack. In a conventional fuel cell stack, although the performance curve is changed to the performance curve “B” from the performance curve “A” due to the performance degradation of the fuel cell stack, a voltage which serves as a reference for charging the battery is constant at V0. In particular, even though the voltage from the fuel cell stack is greater than V0, the chargeable capacity involved in battery charging becomes the region “c” less than the region “a”.

As a result, the battery is not charged as much as it used to be (e.g., not charged as much as it is capable of being charged, not fully charged), and the battery is required to be charged more frequently. As described above, however, when the reference voltage is newly set, the chargeable capacity involved in battery charging becomes the region “b” having the same area as the previous region “a” even though the performance curve is changed to the performance curve “B” from the performance curve “A” due to the performance degradation of the fuel cell. Therefore, even though the performance of the fuel cell stack is degraded, the battery may be charged as much as it used to be.

Meanwhile, in response to determining that the performance of the fuel cell stack is degraded, the reference voltage may be set to the voltage that allows the chargeable capacity to become the predetermined value selected from the range of about 85% to about 100% of the reference capacity with respect to the performance curve at the predetermined time point. For example, the voltage that allows the chargeable capacity to become the value that corresponds to about 95% of the reference capacity may be set as the new reference voltage.

The new reference voltage may be obtained by calculation or may be obtained through a mapping table determined experimentally and stored in the memory. The mapping table may be determined based on the above-described decrease rate. For example, when the decrease rate of the chargeable capacity is about 95%, the new reference voltage that corresponds to the chargeable capacity of about 95% may be previously stored in the memory as the mapping table. The above voltage setting method may be applied to a case where the performance degradation of the fuel cell stack is determined based on the reference current and the evaluated current.

Meanwhile, the instructions stored in the memory of the fuel cell controller, when executed by the processor, may allow the processor to perform the above-mentioned controls. For example, the instructions, when executed by the processor, may allow the processor to determine whether the performance of the fuel cell stack is degraded based on the reference performance that corresponds to the performance of the fuel cell stack evaluated at the reference time point and the evaluated performance that corresponds to the performance of the fuel cell stack evaluated at the predetermined time point after the reference time point and to set the reference voltage, which is set as the maximum allowable voltage for adjusting the voltage of the fuel cell stack, to be less than the existing reference voltage in response to determining that the performance of the fuel cell stack is degraded. In addition, the instructions, when executed by the processor, may allow the processor to charge the electric power produced by the fuel cell stack into the battery when the voltage greater than the reference voltage is generated by the fuel cell stack, and thus the voltage of the fuel cell stack may be decreased.

While the present invention has been described with reference to exemplary embodiments, it will be apparent to those skilled in the art that various changes and modifications may be made without departing from the spirit and scope of the present invention. Therefore, exemplary embodiments of the present invention are not limiting, but illustrative, and the spirit and scope of the present invention is not limited thereto. The spirit and scope of the present invention should be interpreted by the following claims, and it should be interpreted that all technical ideas which are equivalent to the present invention are included in the spirit and scope of the present invention.

What is claimed is:

1. A voltage control method for a fuel cell stack, comprising:
determining, by a controller, whether a performance of the fuel cell stack is degraded based on a reference performance that corresponds to the performance of the fuel cell stack evaluated at a reference time point and an evaluated performance that corresponds to the performance of the fuel cell stack evaluated at a predetermined time point after the reference time point; and
setting, by the controller, a reference voltage, which is set as a maximum allowable voltage for adjusting a voltage of the fuel cell stack, to be less than an existing reference voltage in response to determining that the performance of the fuel cell stack is degraded.

2. The method of claim 1, wherein the reference performance is evaluated based on a reference current that is a maximum current of the fuel cell stack, which is generated at the existing reference voltage, with respect to a time point at which the existing reference voltage is set before the predetermined time point, and the evaluated performance is evaluated based on an evaluated current that is a maximum current generated at the existing reference voltage with respect to the predetermined time point.

3. The method of claim 2, wherein the determination of whether the performance of the fuel cell stack is degraded includes:
determining, by the controller, that the performance of the fuel cell stack is degraded when the evaluated current is less than a predetermined value selected from a range of about 85% to 100% of the reference current.

4. The method of claim 1, wherein, when an electric power derived from a region, defined by an y-axis indicating the voltage, a horizontal line drawn parallel to an x-axis indicating a current at the reference voltage, and a performance curve in a current-voltage performance curve of the fuel cell stack, is referred to as a chargeable capacity, the reference performance is evaluated based on a reference capacity that is the chargeable capacity derived from an initial reference voltage set at a beginning of life with respect to a performance curve of the beginning of life, and the evaluated performance is evaluated based on an evaluated capacity that is the chargeable capacity derived from the existing reference voltage with respect to a performance curve of the predetermined time point.

5. The method of claim 4, wherein the determination of whether the performance of the fuel cell stack is degraded includes:
determining, by the controller, that the performance of the fuel cell stack is degraded when the evaluated capacity is less than a predetermined value selected from a range of about 85% to 100% of the reference capacity.

6. The method of claim 4, wherein the operation (b) comprises setting the reference voltage to a voltage that allows the chargeable capacity to be equal to the reference capacity with respect to the performance curve of the predetermined time point when it is determined that the performance of the fuel cell stack is degraded.

7. The method of claim 4, wherein the setting of the reference voltage includes:
setting, by the controller, the reference voltage to a voltage that allows the chargeable capacity to become a predetermined value selected from a range of about 85% to 100% of the reference capacity with respect to the performance curve of the predetermined time point in response to determining that the performance of the fuel cell stack is degraded.

8. The method of claim 1, wherein, when an electric power derived from a region, defined by an y-axis indicating the voltage, a horizontal line drawn parallel to an x-axis indicating a current at the reference voltage, and a performance curve in a current-voltage performance curve of the fuel cell stack, is referred to as a chargeable capacity and the chargeable capacity derived from an initial reference voltage set at a beginning of life with respect to a performance curve of the beginning of life is referral to as a reference capacity, the setting of the reference voltage includes:
setting, by the controller, the reference voltage to a voltage that allows the chargeable capacity to become a predetermined value selected from a range of about 85% to about 100% of the reference capacity with respect to the performance curve of the predetermined time point in response to determining that the performance of the fuel cell stack is degraded.

9. A fuel cell system for a vehicle, comprising:
at least one processor;
a fuel cell stack connected to the at least one processor;
a battery connected to the at least one processor; and
a memory connected to the at least one processor and configured to store a plurality of instructions, the instructions, when executed by the processor, configured to:
determine whether a performance of the fuel cell stack is degraded based on a reference performance that corresponds to the performance of the fuel cell stack evaluated at a reference time point and an evaluated performance that corresponds to the performance of the fuel cell stack evaluated at a predetermined time point after the reference time point; and
set a reference voltage, which is set as a maximum allowable voltage for adjusting a voltage of the fuel cell stack, to be less than an existing reference voltage in response to determining that the performance of the fuel cell stack is degraded.

10. The fuel cell system of claim 9, wherein the instructions, when executed by the processor, are further configured to:
charge an electric power produced by the fuel cell stack into the battery when the voltage above the reference voltage is generated by the fuel cell stack to decrease the voltage of the fuel cell stack.
